(19) United States
(12) Patent Application Publication
(10) Pub. No.: US 2008/0227628 A1
(43) Pub. Date: Sep. 18, 2008

(54) Silica Nanoboxes, Method of Making and Use thereof

(76) Inventor: Raymond Le Van Mao, Saint-Laurent (CA)

Correspondence Address: GOUDREAU GAGE DUBUC, 2000 MCGILL COLLEGE, SUITE 2200, MONTREAL, QC, H3A 3H3, CA

(21) Appl. No.: 12/089,811

(22) PCT Filed: Oct. 12, 2006
(86) PCT No.: PCT/CA2006/001672

§ 371 Date: Apr. 10, 2008

Related U.S. Application Data
(60) Provisional application No. 60/725,303, filed on Oct. 12, 2005.

(51) Int. Cl. B01J 29/06; C01B 39/02; C01B 39/06; B01J 29/076

(52) U.S. Cl. 502/62; 423/700; 502/64; 502/73; 502/60; 502/74; 502/65; 502/66

(57) ABSTRACT

Disclosed herein are mesoporous material derived from a parent zeolite. In an embodiment of the invention, the mesoporous material derived from a parent zeolite, has an internal volume greater than about 0.35 cc/g and a surface area greater than about 250 m²/g, the mesoporous material comprises micropores having a surface area and mesopores, wherein the surface area of the micropores in the mesoporous material is less than about 25% of that in the parent zeolite, wherein less than about 3% of the internal volume of the mesoporous material is provided by micropores and wherein the mesopores are essentially homogeneously distributed and form an essentially interconnected network. In another embodiment of the invention, the mesoporous material derived from an alumina-rich parent zeolite has an internal volume greater than about 0.25 cc/g and a surface area greater than about 95 m²/g, the mesoporous material comprises micropores having a surface area and mesopores, wherein the surface area of the micropores in the mesoporous material is less than about 25% of that in the parent zeolite, wherein the mesopores are essentially homogeneously distributed and form an essentially interconnected network and wherein the mesoporous material further comprises at least one element selected for the group consisting of cerium, lanthanum and yttrium. Also disclosed are methods of manufacture and uses for the same.

### FIELD OF THE INVENTION

The present invention relates to silica-alumina materials having a regular network of mesoporous cavities.

### BACKGROUND OF THE INVENTION

Zeolites are materials of choices for catalysis and separation technology owing to their microporous network. However, larger substrate molecules require mesoporous materials, also called nanomaterials or nanostructured materials, such as the synthetic MCM-41 from Mobil Oil. These materials exhibit a structure based on a periodic arrangement of mesopores. Unfortunately, these materials are known to be quite thermally and chemically unstable.

Different methods have been proposed to enlarge the pores of zeolites in order to obtain mesoporous materials. These methods are based on the dealumination of the alumina-rich zeolites, i.e. the removal of aluminum atoms, using different dealuminating agents, or the desilication of silica-rich zeolite, i.e. the removal of silica atoms using different desilicating agents.

Some of the most popular dealuminating agents are mineral acids. However, these agents do not allow a controlled dealumination of the zeolites, which usually results in severe structural collapses (see R. Le Van Mao, G. Denes, N. T. C. Vo, J. A. Lavigne, S. T. Le, Mat. Res. Soc. Symp. Proc., Vol. 371 (1995) 123). Furthermore, these materials are subject to pore occlusions that decrease their available surface and internal volume and thus severely limit their usefulness (see Marcilly, in Catatyse acido-basique: Application au raffinage et à la pétrochimie, Ed. Technip, Paris, Vol 2 (2003), 720 and references therein).

Another known dealuminating agent is ammonium hexafluorosilicate (AHFS) (see R. Le Van Mao, G. Denes, N. T. C. Vo, J. A. Lavigne, S. T. Le, Mat. Res. Soc. Symp. Proc., Vol. 371 (1995) 123 and R. Le Van Mao, J. A. Lavigne, B. Sjiariel, C. H. Langford, J. Mater. Chem., 3(6), (1993), 679). This agent is much less aggressive than minerals acids and allows the controlled dealumination of alumina-rich zeolites. Therefore, it can be used for the controlled pore enlargement of different types of zeolites, including A and X type zeolites.

Up to now, the material produced using AHFS had a more or less limited thermal stability. Indeed, calcination of these materials at high temperature usually resulted in a dramatic loss of surface area and sorption volume, and thus, limited the usefulness of these materials as catalysts or adsorbents. It is known that this loss of surface area and sorption volume is due to pore occlusion by aluminic debris moved around during the thermal process (see Marcilly, in Catatyse acido-basique: Application au raffinage et à la pétrochimie, Ed. Technip, Paris, Vol 2 (2003), 720 and references therein). Indeed, some of these debris, trapped inside the mesoporous cavities after the AHFS treatment, agglomerate and form larger internal particles upon calcination, thereby blocking the newly formed mesopores. This explains why, up to now, dealuminated zeolites have not attracted much interest.

Some or the most popular desilicating agents are alkaline solutions, such as solutions of sodium carbonate or sodium hydroxide.

There is thus a need for new and improved mesoporous materials that have interesting pore characteristics such as large internal volumes and surface areas and are suitable for many applications in catalysis and separation technology. Ideally, such materials should be constituted of interconnected and homogenously distributed mesoporous cavities and be thermally resistant.

The present invention seeks to meet these and other needs.

Regarding preferred utility, the mesoporous materials of the invention can be used among other in the biotechnology industry, as catalysts for the production of fine chemicals in the pharmaceutical and fragrance industries and finally, as catalyst for the production of petrochemicals. These nanoboxes are also useful in separation technology and in different environmental applications, such as the selective removal of ions and ionic complexes.

The present description refers to a number of documents, the content of which is herein incorporated by reference in their entirety.

### SUMMARY OF THE INVENTION

The present invention relates to a mesoporous material derived from a parent zeolite, the mesoporous material having an internal volume greater than about 0.35 cc/g and a surface area greater than about 250 m²/g, the mesoporous material comprising micropores having a surface area and mesopores, wherein the surface area of the micropores in the mesoporous material is less than about 25% of that in the parent zeolite, wherein less than about 3% of the internal volume of the mesoporous material is provided by micropores and wherein the mesopores are essentially homogeneously distributed and form an essentially interconnected network.

The mesoporous material may further comprise orthosilicate.

The parent zeolite may be a silica-rich zeolite. The parent zeolite may be ZSM-5.

The parent zeolite may be an alumina-rich zeolite. The parent zeolite may be an X or A type zeolite. The parent zeolite may be NaA, NaX or CaA.

The present invention also relates to a mesoporous material derived from an alumina-rich parent zeolite, the mesoporous material having an internal volume greater than about 0.25 cc/g and a surface area greater than about 95 m²/g, the mesoporous material comprising micropores having a surface area and mesopores, wherein the surface area of the micropores in the mesoporous material is less than about 25% of that in the parent zeolite, wherein the mesopores are essentially homogeneously distributed and form an essentially interconnected network and wherein the mesoporous material further comprises at least one element selected for the group consisting of cerium, lanthanum and yttrium.

The element may be cerium. The element may be lanthanum. The element may be yttrium.

The parent zeolite may be an X or A type zeolite. The parent zeolite may be NaA, NaX or CaA.

The present invention also relates to a method of manufacturing a mesoporous material, the mesoporous material comprising micropores having a surface area and mesopores, the mesoporous material having an internal volume greater than about 0.35 cc/g and a surface area greater than about 250 m²/g, wherein the mesopores are essentially homogeneously distributed and form an essentially interconnected network, the method comprising the step of dealuminating an alumina-rich parent zeolite or desilicating an silica-rich parent zeolite until the surface area of the micropores in the mesoporous material is less than about 25% of that in the parent zeolite, and less than about 3% of the internal volume of the mesoporous material is provided by micropores.

The method may further comprise the step of incorporating orthosilicate in the mesoporous material and activating the orthosilicate at elevated temperature.

The dealumination or desilication step may be a desilication step and the parent zeolite may be a silica-rich zeolite. The parent zeolite may be ZSM-5. The desilication step may be carried out using a sodium carbonate solution.

The dealumination or desilication step may be a dealumination step and the parent zeolite may be an alumina-rich zeolite. The parent zeolite may be an X or A type zeolite. The parent zeolite may be NaA, NaX or CaA. The dealumination step may be carried out using a buffered aqueous solution of ammonium hexafluorosilicate.

The present invention also relates to a method of manufacturing a mesoporous material, the mesoporous material comprising micropores having a surface area and mesopores, the mesoporous material having an internal volume greater than about 0.25 cc/g and a surface area greater than about 95 m²/g, wherein the mesopores are essentially homogeneously distributed and form an essentially interconnected network, the method comprising: dealuminating an alumina-rich parent zeolite until the surface area of the micropores in the mesoporous material is less than about 25% of that in the parent zeolite; and incorporating at least one element selected for the group consisting of cerium, lanthanum and yttrium.

The element may be cerium. The element may be lanthanum. The element may be yttrium. The element may be incorporated by ion-exchange.

The parent zeolite may be an X or A type zeolite. The parent zeolite may be NaA, NaX or CaA. The dealumination step may be carried out using a buffered aqueous solution of ammonium hexafluorosilicate.

This invention also relates to a mesoporous material produced by any of the methods of the invention.

This invention also relates to a catalyst comprising one or more of the mesoporous materials of the invention and further comprising one or more superacidic or strongly acidic species. The superacidic or strongly acidic species may be a trifluoroalkane sulfonic acid. The superacidic or strongly acidic species may be trifluoromethane sulfonic acid.

This invention also relates to a catalyst comprising one or more of the mesoporous materials of the invention. Optionally, the catalyst may further comprise a chemically active species.

The chemically active species may be a metal oxide selected from the group consisting of aluminum oxide, molybdenum oxide, lanthanum oxide, cerium oxide and a mixture of aluminum and molybdenum oxides.

The chemically active species may be zirconium oxide. Optionally the catalyst may further comprise an oxide selected from the group consisting of cerium oxide and lanthanum oxide.

The chemically active species may be a mixture of aluminum oxide, silicon oxide and chromium oxide.

The chemically active species may be fluoride species provided by impregnation with an aqueous solution of ammonium fluoride.

The chemically active species may be a mixture of aluminum oxide and chromium oxide.

The chemically active species may be a mixture of cerium oxide with another oxide selected from the group consisting of molybdenum oxide and tungsten oxide.

The chemically active species may be a mixture of cerium oxide; lanthanum oxide; yttrium oxide; an element selected from the group consisting of phosphorus, sulfur, chlorine and mixtures thereof; an oxide selected from the group consisting of molybdenum oxide, tungsten oxide and mixture thereof; and another oxide selected from the group consisting of zirconium oxide, aluminum oxide and mixtures thereof. Optionally, the catalyst may further comprise an oxide selected from the group of platinum oxide, palladium oxide, iridium oxide and tin oxide.

The catalyst may further comprise a binder. The binder may be bentonite clay.

The catalyst may be used for the production of fine chemicals; for the production of fine chemicals in the fragrance industry; or for the production of petrochemicals. The catalyst may be used in the pharmaceutical industry; in the biotechnology industry; in the thermal catalytic cracking process at a high temperatures; in organic reactions at temperatures lower than 250° C. or in organic reactions at temperatures higher than 250° C.,

The mesoporous material of the invention may be used in separation technology. It may be used for environmental applications. It may be used for the selective removal of ions and ionic complexes.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows the X-ray diffraction patterns at low angle (I=intensity (CPS) versus 20) of the monomodal silica nanoboxes H-deal X. In this figure, A is the diffraction pattern obtained under normal (10) collimation slit arrangement and B is the diffraction patterns recorded under highly collimated slit arrangement (0.10) in which 1) is the sample and 2) is the zero-background holder (to confirm that the diffraction patterns observed are due to a true diffraction and are not an optical artifact due to slits); and

FIG. 2 shows the pore size distribution curves (F=[dV/d log D]) in cm³g⁻¹ versus pore diameter D in 10⁻¹ nm of the new silica nanoboxes. In this figure, A is Na-deal X (calcined), B is H-deal X and C is deal CaA (250° C.).

### DETAILED DESCRIPTION OF THE INVENTION

As used herein the term “silica nanoboxes” is meant to refer to a mesoporous material derived from a parent zeolite, the mesoporous material having an internal volume greater than about 0.25 cc/g and a surface area greater than about 95 m²/g, the mesoporous material comprising micropores having a surface area and mesopores, wherein the surface area of the micropores in the mesoporous material is less than about 25% of that in the parent zeolite, and wherein the mesopores are essentially homogeneously distributed and form an essentially interconnected network.

As used herein the expression “bimodal silica nanoboxes” is meant to refer to silica nanoboxes derived from Al-rich zeolite and having at least a part, for example at least 3%, of its internal volume provided by micropores.

As used herein the expression “stabilized bimodal silica nanoboxes” is meant to refer to a bimodal silica nanoboxes that further comprises an element selected for the group consisting of cerium, lanthanum and yttrium. These mesoporous materials are very thermally stable.

As used herein the expression “monomodal silica nanoboxes” is meant to refer to silica nanoboxes having an internal volume greater than about 0.35 cc/g and a surface area greater than about 250 m²/g and having less than about 3% of its internal volume provided by micropores. These mesoporous materials are very thermally stable and very chemically stable.

Monomodal silica nanoboxes can be produced from zeolites by: 1) dealumination of alumina-rich (Al-rich) zeolites or 2) desilication of silica-rich (Si-rich) zeolites. More generally, any alumina-rich or silica-rich zeolite can be used as a parent zeolite for the production of the silica nanoboxes. The Al-rich may be, without being so limited, NaA, CaA or NaX zeolites. The Si-rich zeolite may be, without being so limited, ZSM-5 zeolites having high Si/Al ratio (highly siliceous zeolites).

As used herein the expressions “micropores” and “microporous cavities” are meant to refer to pores with size smaller than 2 nm.

As used herein the expressions “mesopores” and “mesoporous cavities” are meant to refer to pores with size ranging from 2 nm to about 50 nm.

As used herein the expression “chemically active species” is meant to refer to a chemical entity or a mixture of chemical entities that provides an enhancement of the catalytic properties of zeolites, mesoporous materials or microporous materials.

Many of such chemically active species are known in the art. Examples of such chemically active species are, without being so limited, a metal oxide selected from the group consisting of aluminum oxide, molybdenum oxide, lanthanum oxide, cerium oxide and a mixture of aluminum and molybdenum oxides (see R. Le Van Mao, U.S. Patent Application 2004/0014593); zirconium oxide with, optionally, an oxide selected from the group consisting of cerium oxide and lanthanum oxide (see R. Le Van Mao, U.S. Patent Application 2004/0014593); a mixture of aluminum oxide, silicon oxide and chromium oxide (see R. Le Van Mao, U.S. Patent Application 2003/0181323); fluoride species provided by impregnation with an aqueous solution of ammonium fluoride (R. Le Van Mao and D. Ohayon, U.S. Pat. No. 6,316,679 (Nov. 13, 2001)); a mixture of aluminums oxide and chromium oxide (R. Le Van Mao and D. Ohayon, U.S. Pat. No. 4,732,881 (Mar. 22, 1988)); a mixture of cerium oxide with another oxide selected from the group consisting of molybdenum oxide and tungsten oxide (see International Application PCT/CA03/00105 (WO03064039)); a mixture of cerium oxide, lanthanum oxide, yttrium oxide, with an element selected from the group consisting of phosphorus, sulfur, chlorine and mixtures thereof, with an oxide selected from the group consisting of molybdenum oxide, tungsten oxide and mixture thereof, with another oxide selected from the group consisting of zirconium oxide, aluminum oxide and mixtures thereof and, optionally, with another oxide selected form the group of platinum oxide, palladium oxide, iridium oxide and tin oxide (see co-pending US Patent Application by R. Le Van Mao filed on Apr. 29, 2004, Ser. No. 60/566,081, now published 20050277544).

As used herein the expression “binder” is meant to refer to an inorganic, essentially catalytically inert, material whose role is to embed the silica nanoboxes in its rigid matrix. The binder can be any suitable materials commonly used by as binder for catalysts by those skilled in the art.

As used herein the expression “essentially homogeneously distributed” means that the distribution of the mesopores is mainly homogenous, but need not be perfectly homogeneous. This means that there may be some variations in the number of mesopore in different regions of the material as long as those variations would have no material consequences on the way the mesoporous material of the invention works. Whether given variations in the number of mesopore in different regions have material consequences on the way the invention works can be readily determined by the skilled person in the art by routine testing. One of these test is X-ray diffraction of the material. The fact that the mesopores formed in the mesoporous material of the invention are essentially homogeneously distributed is evidenced in the X-ray diffractogram of the material by an additional peak at low angles when compared to that of the parent zeolite.

As used herein the expression “an essentially interconnected network” means that most of the mesopores in the mesoporous material of the invention are interconnected so as to form a network, but that there is not need for all of the mesopores of the material to be interconnected with each other. This means that there may be a number of mesopores or clusters of mesopores that are not part of the network as long as they would have no material consequences on the way the mesoporous material of the invention works. Whether a given number of unconnected mesopores has material consequences on the way the invention works can be readily determined by the skilled person in the art by routine testing. One of these test is to compare the sum of the surface area obtained by nitrogen adsorption or desorption (S_{cum}) with the surface area determined by the BET method. The fact that the mesopores formed in the new material form an essentially interconnected network is evidenced by the fact that the value of the cumulative surface area in the material obtained by nitrogen adsorption or desorption (S_{cum}) is higher than the surface area determined by the BET method. The BET method is a standard, well-known method and widely used method in surface science for the measurements of surface areas of solids by physical adsorption of gas molecules.

The catalysts described herein are very versatile and can be used in different applications as described above. They can be used, for example, for the production of petrochemicals. An example of such use is, without being so limited, the use of these catalysts in the process of thermal catalytic cracking at high temperature, which is used for the production of light olefins from gas oils and other heavy feedstocks. These catalysts can also be used for organic reactions at temperatures lower than 250° C. or at temperatures higher than 250° C.

The mesoporous material of the present invention can also be used, for example, in separation technology and in environmental applications. An example of such use is, without being so limited, the use of these mesoporous materials for the selective removal of ions and ionic complexes.

The present invention is illustrated in further details by the following non-limiting examples.

### EXAMPLE 1

The mesoporous materials described herein have been produced by controlled dealumination of alumina-rich parent zeolites CaA and NaX and controlled desilication of silica-rich parent zeolite ZSM-5, using an aqueous solution of ammonium hexafluorosilicate (AHFS) or an aqueous solution of sodium carbonate (see the examples below). The dealumination/desilication was continued until the surface area of the micropores was, at least, less than about 25% of that in the parent zeolite. The resulting material had an internal volume at least greater than about 0.25 cc/g and a surface area at least greater than about 150 m²/g.

Controlled dealumination of an alumina-rich and desilication of silica-rich parent zeolite eliminate the micropores in the alumina-rich or silica-rich parent zeolite and creates mesopores in the material. The silica nanoboxes obtained had thus pore openings with sizes in the mesopore region (2-50 nm).

As a general rule for dealumination, the lower the Si/Al atom ratio of the parent zeolite used, the larger the mesopores created in the new materials produced (see R. Le Van Mao, G. Denes, N. T. C. Vo, J. A. Lavigne, S. T. Le, Mat. Res. Soc. Symp. Proc., Vol. 371 (1995) 123; Marcilly, in Catatyse acido-basique: Application au raffinage et à la pétrochimie, Ed. Technip, Paris, Vol 2 (2003), 720 and references therein). For example, in Example 2 (below), the dealumination of a CaA parent zeolite gave monomodal silica nanoboxes with larger mesopores than that obtained by dealumination of a NaX parent zeolite because the treatment with AHFS removed more Al species in the CaA zeolite due to its higher Al content. (See Table 1, D^{op} values for monomodal silica nanoboxes Na-deal X and deal CaA)

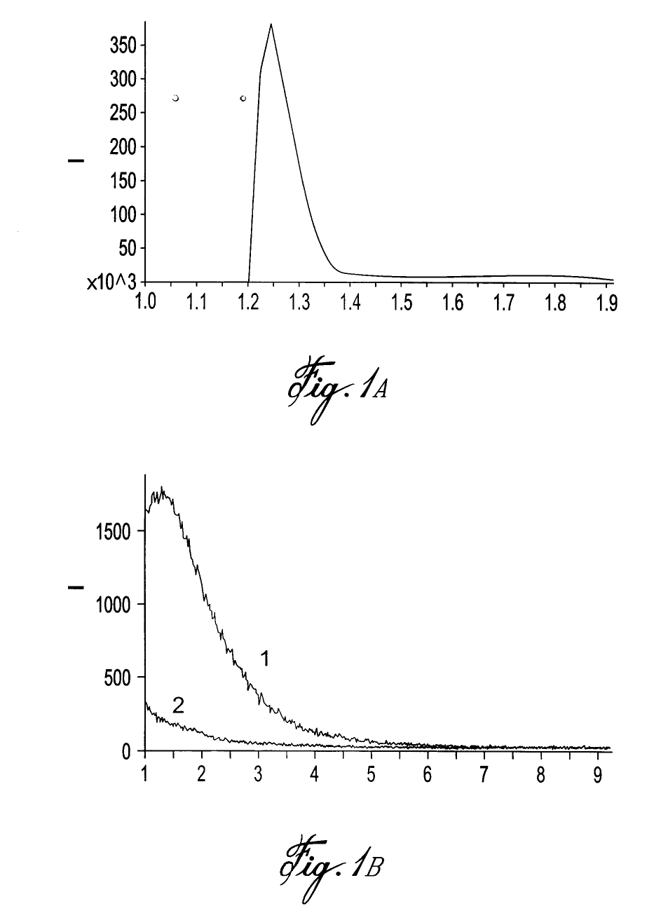

Most importantly, the mesoporous cavities produced by dealumination or desilication were essentially homogeneously distributed in the porous solid, as shown by X-ray diffraction. Indeed, the X-ray powder diffractograms of these nanoboxes showed a new peak at very low angle indicating that these materials contain mesoporous cavities homogeneously distributed in the material. (See FIG. 1 for an example of that for monomodal silica nanoboxes)

Another very important feature of these materials is that the mesoporous cavities form an interconnected network. Indeed, for these materials, the sum of the surface area obtained by nitrogen adsorption or desorption (S_{cum}) was higher than the surface area determined by the BET method indicating that the mesoporous cavities were actually interconnected. (See Table 1 for an example of that for monomodal silica nanoboxes)

### EXAMPLE 2

### Monomodal Silica Nanoboxes

Monomodal silica nanoboxes, showing a regular network of almost entirely mesoporous cavities, were obtained by dealumination of an alumina-rich parent zeolite until the almost entire disappearance of the micropores. More specifically, the controlled dealumination process was carried out until less than about 3% of the internal volume of the resulting material was provided by micropores.

The controlled dealumination of NaX and CaA was carried out with a solution of ammonium hexafluorosilicate (AHFS) as follows: 2.7 g of NaX or 5.0 g of CaA zeolite (in powder form) were placed in a Teflon beaker containing 200 cm³ of 0.8 mol dm⁻³ ammonium acetate solution (pH of ca. 7.0). Then 20 cm³ of a freshly prepared 0.5 mol dm⁻³ ammonium hexafluorosilicate (AHFS) aqueous solution were added, under vigorous stirring, to the suspension using an injection syringe on an infusion pump. The rate of AHFS addition was kept at 0.81 and 1.7 cm³ min⁻¹ for NaX and CaA, respectively. After AHFS addition was completed, the medium was heated at 80° C. in a water bath. The mild stirring was continued for 1 hour. The solid was then separated by filtration and washed on the filter five times, each time with ca. 300 cm³ of distilled water. The product was dried in air in an oven at 110° C. overnight and then activated at 250° C. for 3 h. The resulting solids were named (m) Na-deal X and (m) deal CaA, respectively.

In order to replace Na⁺ by NH₄+ by ion-exchange, the (m) Na-deal X and (m) deal CaA samples were treated with an aqueous solution of NH₄Cl (5 wt %) in a Teflon beaker, using 10 cm³ of NH₄Cl solution for 1 g of (m) Na-deal X or (m) deal CaA, and heated at 80° C. under mild stirring for 2 h. This procedure was repeated twice for a total of 6 h. After each treatment, the used solution was decanted and a fresh solution of NH₄Cl was added. The resulting material was separated by vacuum filtration and washed on the filter with water. The product was dried in an oven at 110° C. overnight in the air and then activated at 250° C. for 4 h. The resulting solid was called herein (m) NH₄-deal X or (m) NH₄-deal CaA).

The acid (or protonic) form (m) H-deal X was obtained by activating the (m) NH₄-deal X sample using a stepwise heating procedure, i.e. 300° C. for 3 h, then gradual heating to 600° C. at a rate of 50° C. per hour, finally heating at 600° C. for 18 h.

The monomodal silica nanoboxes produced showed a regular network of mesoporous cavities interconnected and homogeneously distributed throughout the porous solid. Indeed, the interconnection of the mesoporous cavities was demonstrated by the value of the cumulative surface area (S_{cum}) in the nanoboxes obtained during the desorption phase of nitrogen that was much larger than the value of the BET surface area (Table 1).

In addition, these monomodal silica nanoboxes had an internal volume greater than about 0.35 cc/g and a surface area greater than about 250 m²/g.

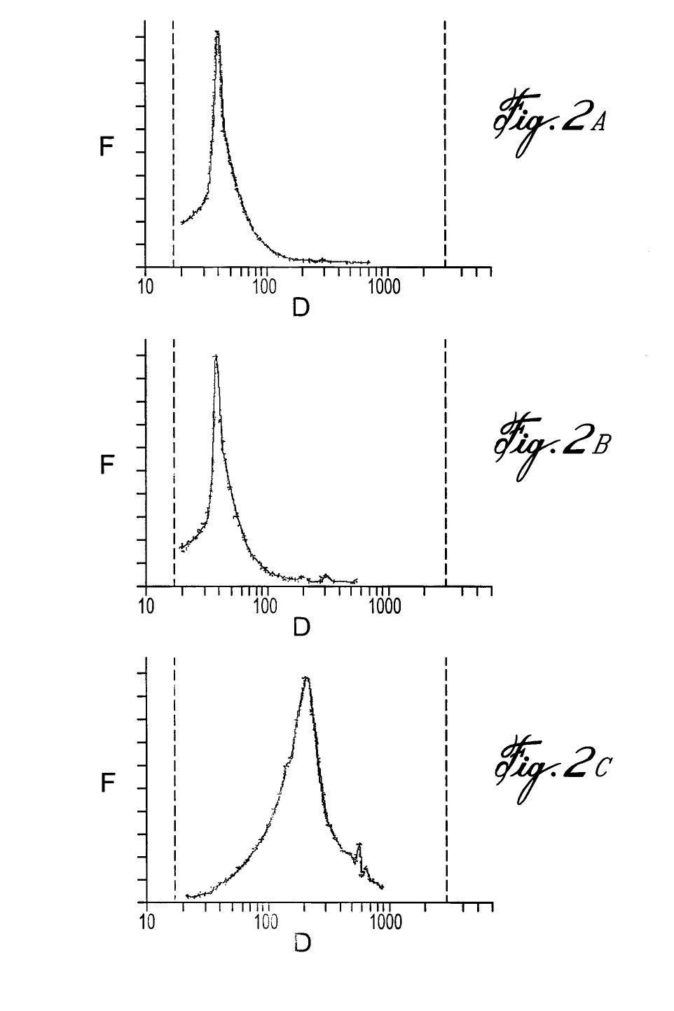

Furthermore, the X-ray powder diffractograms of these nanoboxes showed a new peak at very low angles, which indicates that the mesoporous cavities are homogeneously distributed in the solid (FIG. 1). This peak also means that the monomodal silica nanoboxes have a framework with a high periodicity in nanosized cavities (see FIG. 2 for pore size distribution curves). These diffractograms also showed that the original crystallinity of the parent zeolite almost completely disappeared upon AHFS treatment (Table 1).

The monomodal silica nanoboxes are almost entirely mesoporous material. Indeed, the volume data reported on Table 1 clearly show that only a small fraction of the internal volume of the materials is provided by macropores and micropores. Also, the sorption isotherms of the AHFS treated zeolites (not shown here), showed important hysteresis loops in contrast with the isotherms of the parent zeolites, which were indicative of almost totally mesoporous materials whose cavities were ink-bottle shaped.

TABLE 1
Pore characteristics of monomodal silica nanoboxes

| SAMPLE | BET | S_{cum} | Crystallinity | Dₐᵥ | D^{op} | Vₜₒₜₐₗ | Vₘₑₛₒ | V_{micro} | V_{macro} |
|---|---|---|---|---|---|---|---|---|---|
| (T_{calcination}) | (m²/g) | (m²/g) | (Si/Al) | (nm) | (nm) | (cc/g) | (cc/g) | (cc/g) | (cc/g) |
| NaX | 740 | — | high | 0.8 | 0.8 | 0.31 | 0.03 | 0.28 | 0.00 |
| | | | (1.2) | | | | | | |
| (m) Na-deal X | 451 | 509 | extr. low* | 4.6 | 4.0 | 0.54 | 0.53 | 0.00 | 0 01 |
| (250° C.) | | | (1.7) | | | | | | |
| (m) Na-deal X | 252 | 321 | amorphous* | 4.7 | 4.0 | 0.38 | 0.37 | 0.00 | 0.01 |
| (600° C.) | | | | | | | | | |
| (m) NH₄-deal X | 443 | 528 | amorphous* | 4.7 | 4.1 | 0.57 | 0.52 | 0.00 | 0.05 |
| (250° C.) | | | | | | | | | |
| (m) H-deal X | 328 | 419 | amorphous* | 4.5 | 3.9 | 0.43 | 0.40 | 0.00 | 0.03 |
| (600° C.) | | | | | | | | | |
| CaA | 661 | — | high | 0.5 | 0.5 | 0.27 | 0.02 | 0.25 | 0.00 |
| | | | (1.0) | | | | | | |
| (m) deal-CaA | 251 | 291 | very low* | 15.1 | 14.5 | 0.80 | 0.77 | 0.03 | 0.01 |
| (250° C.) | | | (1.5) | | | | | | |
| (m) deal-CaA | 215 | 236 | amorphous* | 14.0 | 14.1 | 0.72 | 0.67 | 0.01 | 0.01 |
| (600° C.) | | | | | | | | | |

*Except for peak of X-ray powder diffraction at low angle.
(m) denotes a Monomodal silica nanboxes
BET: Surface area (measured by the BET method)
S_{cum}: Cumulative surface areas obtained by nitrogen desorption
Dₐᵥ: Average pore diameter
D^{op}: Average pore opening
Vₜₒₜₐₗ: Total internal volume
Vₘₑₛₒ: Volume of mesopores.
V_{micro}: Volume of micropores
V_{macro}: Volume of the macropores

Most importantly, it was also found that the monomodal silica nanoboxes, obtained when the dealumination is carried out until the almost entire disappearance of the micropores (zero-microporosity) and until the effect of the free interconnections between the newly formed cavities appears through nitrogen adsorption, has a surprising thermal resistance. Indeed, calcination of these materials in air at high temperatures does not significantly change the pore characteristics of the materials. For example, the calcination of (m) Na-deal X and (m) H-deal X at 600° C. resulted in materials that had essentially the same pore size distribution than the original material and that still showed quite high surface area and large sorption volume (Table 1).

This clearly shows that the new dealuminated materials, the monomodal nanoboxes, are very thermally resistant. This is very surprising because the acid and ammonium forms of the parent X or A zeolites undergo a rapid structural collapse even upon moderate heating. For example, the structure of the ammonium form of the X zeolite normally starts to rapidly decompose at ca. 100° C. (see D. W. Breck, in Zeolite Molecular Sieves, J. Wiley & Sons, New York (1974), 495).

### EXAMPLE 3

### Monomodal Silica Nanoboxes

Monomodal silica nanoboxes, herein named (m) Si-nanoboxes, were produced by selective removal of Si species (desilication) as described in the following procedure using as desilicating agent, sodium carbonate monohydrate in aqueous solution (dilute alkaline solution).

Procedure of desilication of Na-ZSM-5 zeolite:

5.0 g of ZSM-5 zeolite (Zeochem, powder form, Na form, SiO₂/Al₂O₃=900, pre-dried at 120° C. overnight) were placed in a Teflon beaker containing 100 cm³ of an 1 M aqueous solution of sodium carbonate monohydrate (Na₂CO₃.H₂O, Aldrich). The suspension was heated at 80° C. under moderate stirring for 5 hours. The suspension was left to settle and then the sodium carbonate solution was replaced by a fresh one. The suspension (zeolite-sodium carbonate solution) was heated again at 80° C. for other 5 hours. Then the solid was separated by filtration, washed with distilled water (about 2,000 cm³) and finally dried in the oven at 120° C. overnight (recovery=44 wt %). The obtained solid, herein called (m) Si-nanoboxes, was finally activated at 600° C. for 3 hours.

The textural characteristics of the mesoporous material obtained are summarized in Table 2.

TABLE 2
Textural characteristics of the (m) Si-nanoboxes
and the parent Na-ZSM-5 zeolite.

| | Surface area BET (m²/g) | | | Average mesopore |
|---|---|---|---|---|
| Sample | Total | micropores | mesopores | diameter (nm) |
| Na-ZSM5 (900) | 423 | 324 | 99 | (not applicable) |
| (m) Si-nanoboxes | 426 | 0 | 426 | 3.4 (1 narrow peak) |

The new material [(m) Si-nanoboxes] shows a sharp peak for the curve of mesopore size distribution, thus suggesting the presence of regularly distributed cavities of 3.4 nm in size (no micropores).

The surface of the new (m) Si-nanoboxes is very hydrophobic (thus, very organophilic), i.e. it does not adsorb water. This is not the case for the (m) Al-nanoboxes, i.e. the nanoboxes produces by dealumination of Al-rich zeolites, whose surface is quite hydrophilic, since this material still contains hydrophilic hydroxyl groups due to tetrahedral Al sites.

These sorptive properties are important when active species are to be incorporated into the nanoboxes. The catalysts or adsorbents resulting from the loading of the active species (for example: acidic or superacidic species) onto these materials will have final properties which strongly depend on the type of matrix (nanoboxes) used.

### EXAMPLE 4

### Acid Loading of Monomodal Silica Nanoboxes

Triflic acid (trifluoromethanesulfonic acid) is one of the strongest acids known (Hammett acidity function Ho=−14.1), yet it is nonoxidizing. It does not provide fluoride ions, and possesses superior thermal stability and resistance to both oxidation and reduction.

Well-defined volumes of aqueous solution of triflic acid (0.0149 g/ml) were added to 0.2 gram of monomodal silica nanoboxes (m) H-deal X to achieve acid loadings of 7.2, 10, 15.6, 23.6, and 32 wt %. The suspension was then placed in a fume hood, at room temperature, for more than 5 h to evaporate all the water. The apparently dried solid was further dried in an oven at 110° C. in air overnight.

The nanoboxes loaded up to 23.6 wt % with triflic acid fairly well preserved their pore characteristics (Table 3). Clearly, these materials have a high chemical resistance, which allows them to withstand triflic acid loadings up to this very significant level. This is very surprising because zeolites usually suffer extensive structural collapse when exposed to strong acids. This high chemical resistance is very advantageous because it allows loading a very vast array of aggressive chemicals into the monomodal silica nanoboxes without compromising the structural integrity of the material.

TABLE 3
Pore characteristics of monomodal silica nanoboxes
(m) H-deal X loaded with triflic acid

| Acid loading | BET | Dₐᵥ | D^{op} | Vₜₒₜₐₗ | Vₘₑₛₒ |
|---|---|---|---|---|---|
| (wt %) | (m²/g) | (nm) | (nm) | (cc/g) | (cc/g) |
| 7.2 | 327 | 4.6 | 4.0 | 0.44 | 0.41 |
| 10.0 | 282 | 4.6 | 3.7 | 0.39 | 0.36 |
| 15.6 | 244 | 4.6 | 3.9 | 0.36 | 0.33 |
| 23.6 | 215 | 4.7 | 3.9 | 0.31 | 0.29 |
| 32.0 | 101 | 5.2 | 4.2 | 0.18 | 0.17 |

### EXAMPLE 5

### Monomodal Silica Nanoboxes with Increased Wall Thickness

It is known from the prior art that orthosilicate (orthosilicic acid) species, when incorporated into the ZSM5 zeolite and subsequently activated at high temperature, can reduce the pore opening from an average of 0.55 nm to 0.47 nm (see R. Le Van Mao and D. Ohayon, U.S. Pat. No. 6,184,167 B1 (Feb. 6, 2001)).

This method was applied to the monomodal silica nanoboxes (m) H-deal X. The resulting material showed a significant decrease in the size of its pore openings (D^{op}) (Table 4). Indeed, the narrowest pore openings (3.7 nm) were obtained when 20 wt % orthosilicate was incorporated in the nanoboxes. The largest pores openings were, of course, found in the material not containing any orthosilicate (3.9 nm).

It was also found that, simultaneously to the decrease in size of the pore openings, the average pore diameter (Dₐᵥ) also decreased to almost the same extent. This suggests that the thickness of the walls of the monomodal silica nanoboxes had been significantly increased. In some cases, for example in cases where aggressive active species are to be grafted onto the walls, it could be very advantageous to use these nanoboxes with thicker, reinforced walls. Furthermore, these thicker walls are covered with OH groups that facilitate the grafting of different chemicals.

TABLE 4
Modifications to the pore characteristics of monomodal
silica nanoboxes (m) H-deal X upon incorporation of
orthosilicate and subsequent thermal treatment

| SiO₄ | BET | Dₐᵥ | D^{op} | Vₜₒₜₐₗ | Vₘₑₛₒ | V_{micro} | V_{macro} |
|---|---|---|---|---|---|---|---|
| (wt %) | (m²/g) | (nm) | (nm) | (cc/g) | (cc/g) | (cc/g) | (cc/g) |
| 5 | 324 | 4.5 | 3.9 | 0.42 | 0.39 | 0.00 | 0.03 |
| 10 | 343 | 4.4 | 3.9 | 0.44 | 0.40 | 0.00 | 0.04 |
| 15 | 348 | 4.4 | 3.8 | 0.43 | 0.39 | 0.00 | 0.04 |
| 20 | 347 | 4.4 | 3.7 | 0.42 | 0.38 | 0.00 | 0.04 |
| 25 | 345 | 4.3 | 3.8 | 0.41 | 0.37 | 0.00 | 0.04 |
| 40 | 331 | 4.2 | 3.8 | 0.38 | 0.34 | 0.00 | 0.04 |

### EXAMPLE 6

### Bimodal Silica Nanoboxes

Stabilized bimodal silica nanoboxes, mostly constituted of mesopores, but also containing micropores, have been produced by controlled dealumination of an alumina-rich parent zeolite using an aqueous solution of ammonium hexafluorosilicate (AHFS) and by further incorporating cerium or lanthanum ions in the zeolite by ion-exchange.

The controlled dealumination of the NaX was carried out with a solution of ammonium hexafluorosilicate (AHFS) as follows: 10.0 g of NaX zeolite (powder) were placed in a Teflon flask containing 200 cm³ of 0.8 mol dm⁻³ ammonium acetate solution. Then 25 cm³ of a freshly prepared 0.5 mol dm⁻³ ammonium hexafluorosilicate (AHFS) aqueous solution were added, under vigorous stirring, to the suspension using an injection syringe on an infusion pump. The rate of AHFS addition was kept at 0.9 cm³/min. Stirring at room temperature was continued for 1 hour. The solid was then separated by filtration and washed on the filter three times, each with ca 200 cm³ of boiling water. The resulting bimodal silica nanoboxes [(b) Na-deal X] was dried in an oven at 110° C. overnight.

In order to replace Na⁺ by NH₄⁺ by ion-exchange, the (b) Na-deal X sample was treated with an aqueous solution of NH₄Cl (5 wt %) in a Teflon beaker heated at 80° C., using 10 cm³ of NH₄Cl solution for 1 g of zeolite, under mild stirring for 2 h. This procedure was repeated twice for a total of 6 h. After each treatment, the used solution was decanted and a fresh solution of NH₄Cl was added. The resulting material was separated by vacuum filtration and washed on the filter with water. The solid product was dried in an oven at 110° C. overnight in the air and then activated at 250° C. for 4 h. The resulting bimodal silica nanoboxes was called (b) NH₄-deal X.

The protonic form [(b) H-deal X] was obtained by calcination and showed extremely low pore characteristics (Table 5). It is proposed that the aluminic species extracted from the microporous portions (zeolite clusters) of this material by the protons generated at high temperature led to serious pore occlusion and to these bad pore characteristics.

(b) NH₄-deal X was thus treated, prior to calcination, by incorporating La or Ce ions by ion-exchange using an aqueous solution of lanthanum or cerium nitrate, 5 wt % using the same method as that with ammonium chloride. The resulting material was then calcined at 600° C. to obtain the stabilized bimodal silica nanoboxes (b) Ce—H deal X and (b) La—H deal X.

The bimodal silica nanoboxes produced had an internal volume greater than about 0.25 cc/g and a surface area greater than about 150 m²/g. They also showed a regular network of mesoporous cavities interconnected and homogeneously distributed throughout the porous solid.

In addition, these bimodal silica nanoboxes advantageously contained micropores in addition to the newly formed mesopores. It is worth noting that the micropores are located inside the newly created mesopores. An experimental evidence of this is that these “zeolite” microporous remnants, if they are not stabilized by Ce, La or Y, lead to the occlusion of the mesopores when calcined at high temperature.

This bimodal system is very different in catalytic behavior from a mere mechanical mixture. As a result of the presence of these micropores, the walls of these nanoboxes are “acidified” by some clusters of microporous zeolites, which are normally very acidic if there are in the protonic form. The incorporation of these acidic species onto the one surface of mesoporous materials provide interesting acid catalysts with cavities sufficiently large to convert bulky molecules. In other words, for use as catalysts in some organic reactions, which require acid sites from solid catalysts, it is advantageous not to completely eliminate the micropores, so that acid sites of some remaining zeolite clusters coating the internal surface of the newly created nanocavities can contribute to the catalytic reaction.

Bimodal silica nanoboxes as synthesized are not thermally resistant. Indeed, when (b) NH₄-deal X silica nanoboxes not containing cerium, lanthanum of yttrium species were calcined at high temperature, pore occlusion occurred and resulted in a dramatic loss of surface area and sorption volume. However, when this material was treated beforehand with an aqueous solution of lanthanum or cerium ions, the corresponding samples calcined at 600° C. or higher, kept interesting pore characteristics (Table 5). Thus, the incorporation of these ions resulted in the stabilization of the (microporous) zeolite clusters coating the internal walls of the silica nanoboxes and rendered the final material very thermally resistant.

TABLE 5
Pore characteristics of bimodal silica nanoboxes

| SAMPLE | Ion-exchange | BET | S_{mic} | S_{mic} | Dₐᵥ | Vₜ | Vₘₑₛ | V_{mic} |
|---|---|---|---|---|---|---|---|---|
| (T_{calcination}) | (hour) | (m²/g) | (m²/g) | (%) | (nm) | (cc/g) | (cc/g) | (cc/g) |
| (b) NH₄-deal X | — | 333 | 121 | 36 | — | 0.38 | 0.33 | 0.05 |
| (250° C.) | | | | | | | | |
| (b) H-deal X | — | 8 | 0 | 0 | — | 0.02 | 0.02 | 0.00 |
| (700° C.) | | | | | | | | |
| (b) La [1] H-deal X | 2 | 95 | 0 | 0 | 6.8 | 0.22 | 0.22 | 0.00 |
| (b) La [2] H-deal X | 4 | 163 | 36 | 22 | 6.3 | 0.29 | 0.27 | 0.02 |
| (700° C.) | | | | | | | | |
| (b) Ce [1] H-deal X | 2 | 145 | 25 | 17 | 6.8 | 0.29 | 0.28 | 0.01 |
| (700° C.) | | | | | | | | |

(b) denotes a Bimodal silica nanoboxes

### EXAMPLE 7

### Acidic Catalyst

An acidic catalyst was prepared by extrusion of (b) Ce [1] H-deal X of Example 6 with bentonite clay. This catalyst showed very interesting activity and product selectivities (Table 6) in the conversion of petroleum gas oil into light olefins (the TCC or thermocatalytic process), which is an alternative process to the current steam-cracking technology.

TABLE 6
Performance of one (b) Ce [1] H-deal X in the TCC process

| | Steam-cracking | TCC |
|---|---|---|
| Gas Oil | Kuwait | AGO-2 |
| Density (g/ml) | 0.832 | 0.860 |
| Bp (° C.) | 230-330 | 175-400 |
| Temperature (° C.) | 850 | 725 |
| (residence time) | (0.3 s) | (0.3 s) |
| Ethylene (wt %) | 26.0 | 20.6 |
| Propylene (wt %) | 9.0 | 17.9 |
| Gasoline (wt %) | 20.6 | 25.1 |
| (incl. BTX) | | |
| 200-400° C. (wt %) | 19.0 | 8.3 |
| (>400° C.) | (yes) | (yes) |
| Methane (wt %) | 13.7 | 10.2 |
| Ethylene + Propylene (wt %) | 35.0 | 38.5 |
| Ethylene/Propylene | 2.9 | 1.1 |

Although the present invention has been described hereinabove by way of specific embodiments thereof, it can be modified, without departing from the spirit and nature of the subject invention as defined in the appended claims.

1. A mesoporous material derived from a parent zeolite, said mesoporous material having an internal volume greater than about 0.35 cc/g and a surface area greater than about 250 m²/g, said mesoporous material comprising micropores having a surface area and mesopores, wherein the surface area of the micropores in said mesoporous material is less than about 25% of that in the parent zeolite, wherein less than about 3% of the internal volume of said mesoporous material is provided by micropores and wherein the mesopores are essentially homogeneously distributed and form an essentially interconnected network.

2. The mesoporous material of claims 1 further comprising orthosilicate.

3. The mesoporous material of claim 1, wherein said parent zeolite is a silica-rich zeolite.

4. The mesoporous material of claim 3 wherein said parent zeolite is ZSM-5.

5. The mesoporous material of claim 1, wherein said parent zeolite is an alumina-rich zeolite.

6. The mesoporous material of claim 5 wherein said parent zeolite is an X or A type zeolite.

7. The mesoporous material of claim 6 wherein said parent zeolite is NaA, NaX or CaA.

8. A mesoporous material derived from an alumina-rich parent zeolite, said mesoporous material having an internal volume greater than about 0.25 cc/g and a surface area greater than about 95 m²/g, said mesoporous material comprising micropores having a surface area and mesopores, wherein the surface area of the micropores in said mesoporous material is less than about 25% of that in the parent zeolite, wherein the mesopores are essentially homogeneously distributed and form an essentially interconnected network and wherein said mesoporous material further comprises at least one element selected for the group consisting of cerium, lanthanum and yttrium.

9. The mesoporous material of claim 8 wherein said element is cerium.

10. The mesoporous material of claim 8 wherein said element is lanthanum.

11. The mesoporous material of claim 8 wherein said element is yttrium.

12. The mesoporous material of claim 8 wherein said parent zeolite is an X or A type zeolite.

13. The mesoporous material of claim 12 wherein said parent zeolite is NaA, NaX or CaA.

14. A method of manufacturing a mesoporous material, said mesoporous material comprising micropores having a surface area and mesopores, said mesoporous material having an internal volume greater than about 0.35 cc/g and a surface area greater than about 250 m²/g, wherein said mesopores are essentially homogeneously distributed and form an essentially interconnected network, said method comprising the step of dealuminating an alumina-rich parent zeolite or desilicating an silica-rich parent zeolite until:
(a) the surface area of the micropores in said mesoporous material is less than about 25% of that in the parent zeolite, and
(b) less than about 3% of the internal volume of said mesoporous material is provided by micropores.

15. The method of claim 14 further comprising incorporating orthosilicate in the mesoporous material and activating said orthosilicate at elevated temperature.

16. The method of claim 14 wherein said dealumination or desilication step is a desilication step and said parent zeolite is a silica-rich zeolite.

17. The method of claim 16 wherein said parent zeolite is ZSM-5.

18. The method of claim 16 wherein said desilication step is carried out using a sodium carbonate solution.

19. The method of claim 14 wherein said dealumination or desilication step is a dealumination step and said parent zeolite is an alumina-rich zeolite.

20. The method of claim 19 wherein said parent zeolite is an X or A type zeolite.

21. The method of claim 20 wherein said parent zeolite is NaA, NaX or CaA.

22. The method of claim 19 wherein said dealumination step is carried out using a buffered aqueous solution of ammonium hexafluorosilicate.

23. A method of manufacturing a mesoporous material, said mesoporous material comprising micropores having a surface area and mesopores, said mesoporous material having an internal volume greater than about 0.25 cc/g and a surface area greater than about 95 m²/g, wherein said mesopores are essentially homogeneously distributed and form an essentially interconnected network, said method comprising:
(a) dealuminating an alumina-rich parent zeolite until the surface area of the micropores in said mesoporous material is less than about 25% of that in the parent zeolite; and
(b) incorporating at least one element selected for the group consisting of cerium, lanthanum and yttrium.

24. The method of claim 23 wherein said element is cerium.

25. The method of claim 23 wherein said element is lanthanum.

26. The method of claim 23 wherein said element is yttrium.

27. The method of claim 23, wherein said element is incorporated by ion-exchange.

28. The method of claim 23 wherein said parent zeolite is an X or A type zeolite.

29. The method of claim 28 wherein said parent zeolite is NaA, NaX or CaA.

30. The method of claim 23 wherein said dealumination step is carried out using a buffered aqueous solution of ammonium hexafluorosilicate.

31. A mesoporous material produced by the method of claim 14.

32. A mesoporous material produced by the method of claim 23.

33. A catalyst comprising one or more of the mesoporous materials according to claim 1 and further comprising one or more superacidic or strongly acidic species.

34. The catalyst of claim 33 wherein said superacidic or strongly acidic species is a trifluoroalkane sulfonic acid.

35. The catalyst of claim 34 wherein said superacidic or strongly acidic species is trifluoromethane sulfonic acid.

36. A catalyst comprising one or more of the mesoporous materials of claim 1.

37. The catalyst of claim 36 further comprising a chemically active species.

38. The catalyst of claim 37 wherein said chemically active species is selected from the group consisting of:
a metal oxide selected from the group consisting of aluminum oxide, molybdenum oxide, lanthanum oxide, cerium oxide and a mixture of aluminum and molybdenum oxides;
zirconium oxide;
zirconium oxide and an oxide selected from the group consisting of cerium oxide and lanthanum oxide;
a mixture of aluminum oxide, silicon oxide and chromium oxide;
fluoride species provided by impregnation with an aqueous solution of ammonium fluoride;
a mixture of aluminum oxide and chromium oxide;
a mixture of cerium oxide with another oxide selected from the group consisting of molybdenum oxide and tungsten oxide;
a mixture of cerium oxide; lanthanum oxide; yttrium oxide; an element selected from the group consisting of phosphorus, sulfur, chlorine and mixtures thereof; an oxide selected from the group consisting of molybdenum oxide, tungsten oxide and mixture thereof; and another oxide selected from the group consisting of zirconium oxide, aluminum oxide and mixtures thereof; and
a mixture of cerium oxide; lanthanum oxide; yttrium oxide; an element selected from the group consisting of phosphorus, sulfur, chlorine and mixtures thereof; an oxide selected from the group consisting of molybdenum oxide, tungsten oxide and mixture thereof; another oxide selected from the group consisting of zirconium oxide, aluminum oxide and mixtures thereof and an oxide selected from the group of platinum oxide, palladium oxide, iridium oxide and tin oxide.

39. The catalyst of claim 33 further comprising a binder.

40-49. (canceled)

50. A catalyst comprising one or more of the mesoporous materials of claim 8.

51. The catalyst of claim 50 further comprising a chemically active species.

52. The catalyst of claim 51 wherein said chemically active species is selected from the group consisting of:
a metal oxide selected from the group consisting of aluminum oxide, molybdenum oxide, lanthanum oxide, cerium oxide and a mixture of aluminum and molybdenum oxides;
zirconium oxide;
zirconium oxide and an oxide selected from the group consisting of cerium oxide and lanthanum oxide;
a mixture of aluminum oxide, silicon oxide and chromium oxide;
fluoride species provided by impregnation with an aqueous solution of ammonium fluoride;
a mixture of aluminum oxide and chromium oxide;
a mixture of cerium oxide with another oxide selected from the group consisting of molybdenum oxide and tungsten oxide;
a mixture of cerium oxide; lanthanum oxide; yttrium oxide; an element selected from the group consisting of phosphorus, sulfur, chlorine and mixtures thereof; an oxide selected from the group consisting of molybdenum oxide, tungsten oxide and mixture thereof; and another oxide selected from the group consisting of zirconium oxide, aluminum oxide and mixtures thereof; and
a mixture of cerium oxide; lanthanum oxide; yttrium oxide; an element selected from the group consisting of phosphorus, sulfur, chlorine and mixtures thereof; an oxide selected from the group consisting of molybdenum oxide, tungsten oxide and mixture thereof; another oxide selected from the group consisting of zirconium oxide, aluminum oxide and mixtures thereof and an oxide selected from the group of platinum oxide, palladium oxide, iridium oxide and tin oxide.

53. The catalyst of claim 36 further comprising a binder.

54. The catalyst of claim 50 further comprising a binder.
